(19) United States
(12) Patent Application Publication
(10) Pub. No.: US 2025/0105653 A1
(43) Pub. Date: Mar. 27, 2025

(54) POWER RECEIVING SYSTEM, ROBOT, POWER RECEIVING METHOD, AND RECORDING MEDIUM

(71) Applicant: CASIO COMPUTER CO., LTD., Tokyo (JP)

(72) Inventors: Hirokazu HASEGAWA, Tokyo (JP); Erina ICHIKAWA, Tokyo (JP); Kouki MAYUZUMI, Tokyo (JP)

(73) Assignee: CASIO COMPUTER CO., LTD., Tokyo (JP)

(21) Appl. No.: 18/894,186

(22) Filed: Sep. 24, 2024

(30) Foreign Application Priority Data
Sep. 25, 2023 (JP) 2023-159695

(51) Int. Cl. H02J 7/00; H02J 50/10

(52) U.S. Cl. CPC H02J 7/007182; H02J 7/0048; H02J 50/10

(57) ABSTRACT

The power receiving system includes a power receiver, a battery and one or more processors. The power receiver receives power from a power supply device. The battery is accommodated in the robot and is to be charged with power received by the power receiver. In a case where a determination is made that an amount of charge of the battery is determined to be less than a predetermined amount of charge, the one or more processors control the robot and sets an energy saving mode of the robot, and in a case where a determination is made that the amount of charge of the battery is equal to or greater than the predetermined amount of charge, the one or more processors release setting of the energy saving mode and controls to receive power that is equal to or greater than a reference power consumption corresponding to the energy saving mode.

### CROSS-REFERENCE TO RELATED APPLICATIONS

This application claims the benefit of Japanese Patent Application No. 2023-159695, filed on Sep. 25, 2023, the entire disclosure of which is incorporated by reference herein.

### FIELD OF THE INVENTION

The present disclosure relates to a power receiving system, a robot, a power receiving method, and a recording medium.

### BACKGROUND OF THE INVENTION

Unexamined Japanese Patent Application Publication No. 2013-212043 discloses a non-contact charging device including a resonance circuit and a rectifier circuit. This non-contact charging device includes a charging/discharging control circuit and a voltage monitoring circuit between the rectifier circuit and a battery. Further, the non-contact charging device changes impedance of the resonance circuit in a state in which the battery is fully charged, and changes the resonance circuit from a first power receiving state in which the power receiving state is optimum to a second power receiving state in which the power receiving state significantly worse.

### SUMMARY OF THE INVENTION

In order to achieve the aforementioned objective, a power receiving system according to the present disclosure includes:
a power receiver to receive power from a power supply device that sends power corresponding to power consumption and power to be used for charging of a robot that is a target for power supply;
a battery accommodated in the robot and to be charged with power received by the power receiver; and
one or more processors to control the robot, wherein
in a case where a determination is made that an amount of charge of the battery is determined to be less than a predetermined amount of charge, the one or more processors set an energy saving mode of the robot, and in a case where a determination is made that the amount of charge of the battery is equal to or greater than the predetermined amount of charge, the one or more processors release setting of the energy saving mode and controls to receive power that is equal to or greater than a reference power consumption corresponding to the energy saving mode.

### BRIEF DESCRIPTION OF DRAWINGS

A more complete understanding of this application can be obtained when the following detailed description is considered in conjunction with the following drawings, in which:

FIG. 1 is a drawing illustrating a schematic of the entire configuration of a power receiving system according to an embodiment;

FIG. 2 is a cross-sectional view of a robot according to the embodiment, viewed from the side;

FIG. 3 is a drawing illustrating a housing of the robot according to the embodiment;

FIG. 4 is a drawing illustrating a situation where power is supplied from a power supply device to the robot according to the embodiment;

FIG. 5 is a block diagram illustrating a hardware configuration of the power supply device and the robot according to the embodiment;

FIG. 6 is a block diagram illustrating a configuration of a control module in the power supply device according to the embodiment;

FIG. 7 is a block diagram illustrating a configuration of a control module in the robot according to the embodiment; and

FIG. 8 is a flowchart illustrating charging processing according to the embodiment.

### DETAILED DESCRIPTION OF THE INVENTION

Hereinafter, embodiments of the present disclosure are described with reference to the drawings. In these drawings, the components identical or corresponding to each other are provided with the same reference numerals.

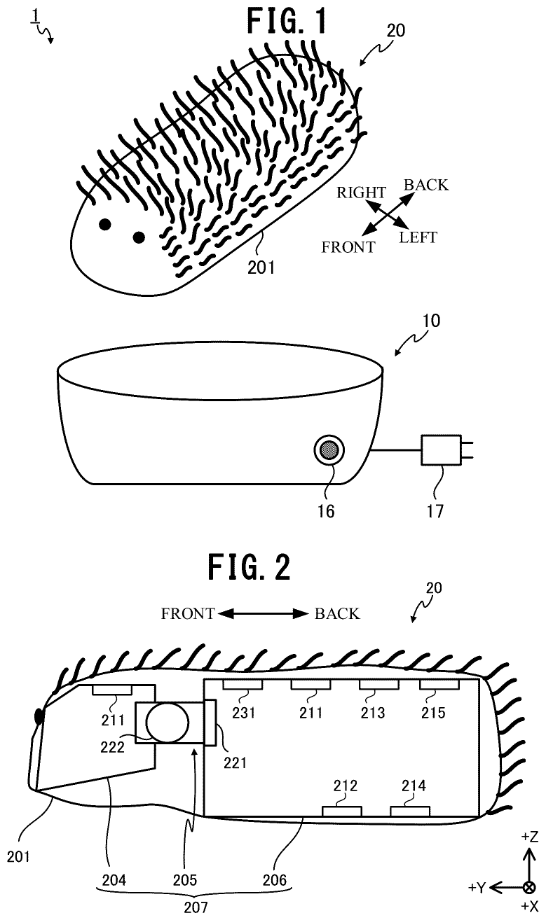

FIG. 1 schematically illustrates a configuration of a power receiving system 1 according to an embodiment. The power receiving system 1 includes a power supply device 10 and a robot 20. The power receiving system 1 is a non-contact power receiving system that allows the robot 20, a target for power supply, to receive power from the power supply device 10 by non-contact power supply. The non-contact power supply is also called wireless power supply, and is a technique for supplying power from a device on a power supply side to a device on a power reception side without interposing connection of a cable, contact of a metal electrode, and the like.

Here, the non-contact power supply is a control method for adjusting transmission power to power at the reception side. In such a method, the transmission power from the power supply device 10 decreases when the charging state is in the vicinity of full charge. Thus, if the robot 20 largely moves during charging, the transmission power from the power supply device 10 may possibly be interrupted.

The robot 20 is a device that autonomously acts without direct operations by a user. The robot 20 is a pet robot that resembles a small animal. The robot 20 includes an exterior 201 provided with decorative parts resembling eyes, and bushy fur.

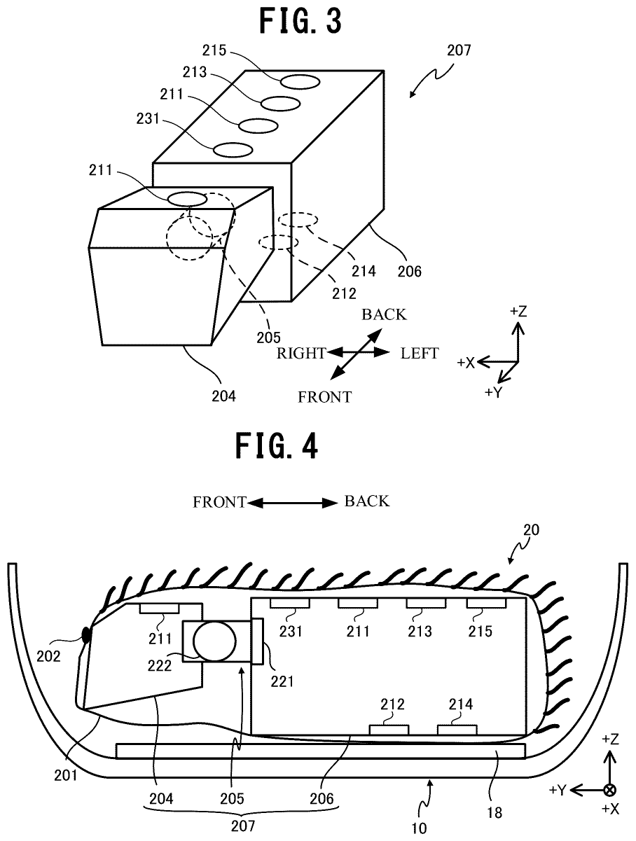

As illustrated in FIGS. 2 and 3, the robot 20 includes a housing 207. The housing 207 is covered by the exterior 201, and is accommodated inside the exterior 201. The housing 207 includes a head 204, a coupler 205, and a torso 206. The coupler 205 couples the head 204 to the torso 206.

The exterior 201 is an example of an exterior member, is elongated in a front-back direction, and has a bag-like shape that is capable of accommodating the housing 207 therein. The exterior 201 is formed in a barrel shape from the head 204 to the torso 206, and integrally covers the torso 206 and the head 204.

Due to the exterior 201 having such a shape, the robot 20 is formed in a shape as if lying on its belly.

An outer material of the exterior 201 is formed from an artificial pile fabric that resembles the fur of a small animal to imitate the feel of a small animal. A lining of the exterior 201 is formed from synthetic fibers, natural fibers, natural leather, artificial leather, a synthetic resin sheet material, a rubber sheet material, or the like. The exterior 201 is formed from such a flexible material and, as such, conforms to the movement of the housing 207. Specifically, the exterior 201 conforms to the rotation of the head 204 relative to the torso 206.

The torso 206 extends in the front-back direction, and is in contact, via the exterior 201, with a placement surface of a floor, a table, or the like where the robot 20 is placed. The torso 206 includes a twist motor 221 at a front end thereof. The head 204 is coupled to the front end of the torso 206 via the coupler 205. The coupler 205 includes a vertical motor 222. Note that, in FIG. 2, the twist motor 221 is provided on the torso 206, but may be provided on the coupler 205. The head 204 is rotatably coupled to the torso 206 by the twist motor 221 and the vertical motor 222, with a left-right direction and the front-back direction of the robot 20 as axes. The torso 206 is one example of robot body. The head 204 is one example of a movable portion.

Note that, as XYZ coordinate axes, an X axis and a Y axis are set in the horizontal plane, and a Z axis is set in the vertical direction. The +direction of the Z axis corresponds to vertically upward. Moreover, to facilitate comprehension, in the following, a description is given in which the robot 20 is placed on the placement surface and oriented such that the left-right direction (the width direction) of the robot 20 is the X axis direction and the front-back direction of the robot 20 is the Y axis direction.

The coupler 205 couples the torso 206 to the head 204 so as to enable rotation around a first rotational axis that passes through the coupler 205 and extends in the front-back direction (the Y direction) of the torso 206. The twist motor 221 rotates the head 204, with respect to the torso 206, clockwise (right rotation) within a forward rotation angle range (forward rotation), counterclockwise (left rotation) within a reverse rotation angle range (reverse rotation), and the like.

Additionally, the coupler 205 couples the torso 206 to the head 204 so as to enable rotation around a second rotational axis that passes through the coupler 205 and extends in the left-right direction (the width direction, the X direction) of the torso 206. The vertical motor 222 rotates the head 204 upward (forward rotation) within a forward rotation angle range, downward (reverse rotation) within a reverse rotation angle range, and the like.

As illustrated in FIGS. 2 and 3, the robot 20 includes a touch sensor 211 on each of the head 204 and the torso 206. The robot 20 can detect, by the touch sensor 211, petting or striking of the head 204 or the torso 206 by the user.

The robot 20 includes, on the torso 206, an acceleration sensor 212, a microphone 213, a gyrosensor 214, an illuminance sensor 215, and a speaker 231. By using the acceleration sensor 212 and the gyrosensor 214, the robot 20 can detect a change of an attitude of the robot 20 itself, and can detect being picked up, the orientation being changed, being thrown, and the like by the user. The robot 20 can detect the ambient illuminance of the robot 20 by using the illuminance sensor 215. The robot 20 can detect external sounds by using the microphone 213. The robot 20 can emit sounds by using the speaker 231.

Note that, at least a portion of the acceleration sensor 212, the microphone 213, the illuminance sensor 214, the gyrosensor 215, and the speaker 231 is not limited to being provided on the torso 206 and may be provided on the head 204, or may be provided on both the torso 206 and the head 204.

Referring back to FIG. 1, the power supply device 10 is a device for supplying power to the robot 20 by the non-contact power supply (wireless power supply). The power supply device 10 functions as a charging station for charging the robot 20. The power supply device 10 includes a notifier 16 outside a side wall. The power supply device 10 receives power supply from a commercial power source via an alternate current (AC) adapter 17.

The power supply device 10 is installed at an appropriate place where the robot 20 can autonomously move to the power supply device 10. The robot 20 moves to the power supply device 10 in order to charge a battery when an amount of charge of the battery is at a lower limit value or lower, or when a predetermined timing arrives.

As illustrated in FIG. 4, the power supply device 10 includes a stand 18 being a placement portion for placing the robot 20. The power supply device 10 has a bowl shape surrounding the robot 20 by the side wall while the robot 20 is placed on the stand 18.

A power transmitting coil is provided inside the stand 18. The power supply device 10 can wirelessly charge a battery using electromagnetic induction, magnetic resonance, electric field coupling, or a similar known method while the robot 20 is placed on the stand 18. Hereinafter, an example of a method of electromagnetic induction is described.

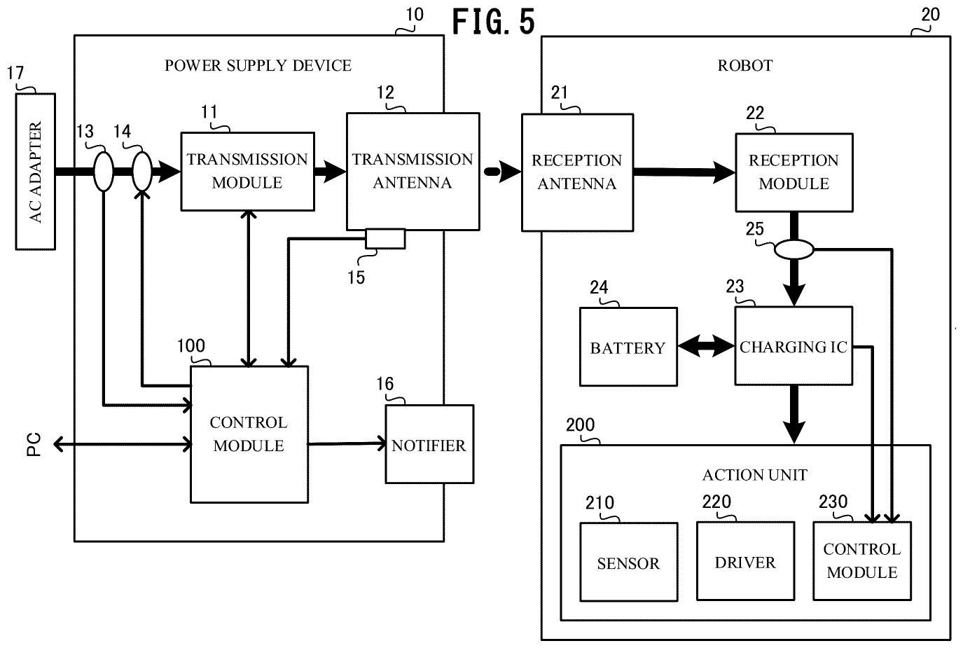

As illustrated in FIG. 5, the power supply device 10 includes a transmission module 11, a transmission antenna 12, a current sensor 13, a switch 14, a thermistor 15, a notifier 16, and a control module 100.

The transmission module 11 receives power supplied from the AC adapter 17 and supplies the power to the transmission antenna 12. The transmission module 11 includes, for example, a conversion circuit that converts the power supplied from the AC adapter 17 into power to be supplied to the transmission antenna 12. The conversion circuit raises a voltage value of the power supplied from the AC adapter 17 to a predetermined voltage value, and converts the power into an alternating current at a predetermined frequency. The transmission module 11 supplies the alternating current resulting from the conversion by the conversion circuit to the transmission antenna 12.

The transmission antenna 12 includes a power transmitting coil for transmitting power to the robot 20. The power transmitting coil is a lead wire wound in a spiral shape inside the stand 18. In the transmission antenna 12, alternating-current power supplied from the transmission module 11 flows through the power transmitting coil. As such, an induced magnetic flux is generated. The transmission antenna 12 transmits power to the robot 20 by the induced magnetic flux generated in the power transmitting coil.

Note that the transmission module 11 and the transmission antenna 12 are collectively referred to as a “power supplier”. The power supplier is one example of power supplying means for performing non-contact power supply to the robot 20.

The current sensor 13 is installed between the AC adapter 17 and the transmission module 11, and measures a current flowing through a path between the AC adapter 17 and the transmission module 11. The current sensor 13 supplies a value of the measured current to the control module

The switch 14 includes, for example, a field effect transistor (FET). The switch 14 switches between supply and cutoff (ON and OFF) of power supplied from the AC adapter 17 to the transmission module 11 in accordance with a switch signal transmitted from the control module 100.

The thermistor 15 is installed on the transmission antenna 12, and measures a temperature of the transmission antenna 12. The thermistor 15 supplies a value of the measured temperature to the control module 100.

The notifier 16 is one example of notification means for providing notification in accordance with a state of the power supply device 10. Specifically, the notifier 16 includes light emitting diodes (LEDs) of three colors, red, green, and blue, that are indicator lamps. The notifier 16 notifies a user of a current state of the power supply device 10 by lighting/flushing each of the LEDs of three colors in various patterns. As illustrated in FIG. 1, the notifier 16 is installed outside the side wall of the power supply device 10 at a position where the user can easily confirm.

Referring back to FIG. 5, the robot 20 includes a reception antenna 21, a reception module 22, a charging integrated circuit (IC) 23, a battery 24, a voltage sensor 25, and an action unit 200.

The reception antenna 21 receives power supplied from the power supply device 10. The reception antenna 21 includes a power receiving coil that receives power transmitted from the transmission antenna 12. The power receiving coil is wound at a position facing the power transmitting coil of the transmission antenna 12 while the robot 20 is placed on the stand 18. In the power receiving coil, electromotive force is induced in response to a change in an induced magnetic flux generated in the power transmitting coil of the transmission antenna 12. The reception antenna 21 supplies the electromotive force induced in the power receiving coil to the reception module 22.

The reception module 22 receives power supplied from the reception antenna 21, and supplies the power to the charging IC 23. The reception module 22 includes, for example, a conversion circuit that converts alternating-current power supplied from the reception antenna 21 into direct-current power. The conversion circuit rectifies electromotive force induced in the power receiving coil of the reception antenna 21 to generate direct-current power, and supplies the generated direct-current power to the charging IC 23.

Note that the reception antenna 21 and the reception module 22 are collectively referred to as a “power receiver”. The power receiver is one example of power receiving means for receiving power supplied from the power supply device 10.

The charging IC 23 controls charging and discharging in the battery 24. Furthermore, the charging IC 23 measures the amount of charge of the battery 24, and outputs data indicating the measured amount of charge to the control module 230 The battery 24 is a chargeable secondary battery, and stores power to be used in the robot 20. In a case where the charging IC 23 is supplied with power from the reception module 22, the charging IC 23 charges the battery 24 with the supplied power. Further, in a case where the action unit 200 needs power, the charging IC 23 discharges power stored in the battery 24 to supply the power to the action unit 200.

The voltage sensor 25 is installed between the reception module 22 and the charging IC 23, and measures an output voltage from the reception module 22 to the charging IC 23. Whether the battery 24 is being charged can be determined by a measurement result of the voltage sensor 25.

The action unit 200 is a unit that causes the robot 20 to perform an action. The action unit 200 includes a sensor 210, a driver 220, and a control module 230. Note that the action unit 200 is one example of controlling means for controlling the robot 20.

The sensor 210 includes the touch sensor 211, the acceleration sensor 212, the microphone 213, the gyrosensor 214, and the illuminance sensor 215 described above. The controller 110 acquires, via a bus line, a detection value detected by various sensors of the sensor 210 as an external stimulus.

The driver 220 includes the twist motor 221 and the vertical motor 222, and is driven by the control module 230. The twist motor 221 is a servo motor to rotate the head 204, with respect to the torso 206, in the left-right direction (the width direction) with the front-back direction as an axis.

The vertical motor 222 is a servo motor to rotate the head 204, with respect to the torso 206, in the up-down direction (the height direction) with the left-right direction as an axis. The robot 20 can express an action of twisting the head 204 sideways by using the twist motor 221, and can express an action of lifting/lowering the head 204 by using the vertical motor 222.

The control module 230 comprehensively controls the entire robot 20. Although not illustrated, the control module 230 includes a controller such as a central processing unit (CPU), a storage such as a read only memory (ROM), a random access memory (RAM), and a flash memory, and a communicator for communicating with external apparatuses.

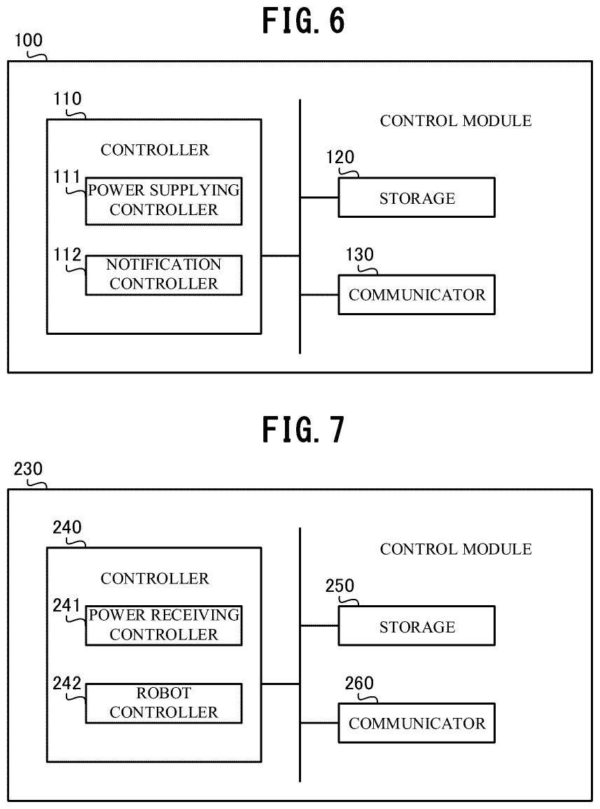

Next, with reference to FIG. 6, a configuration of the control module 100 of the power supply device 10 is described. The control module 100 includes a controller 110, a storage 120, and a communicator 130.

The controller 110 includes a CPU. In one example, the CPU is a microprocessor or the like, and is a central processing unit that executes a variety of processing and computations. In the controller 110, the CPU controls actions of the entire power supply device 10 by reading a control program stored in a ROM and using a RAM as a work memory. The controller 110 may also be called a “processor.”

The storage 120 includes the ROM, the RAM, a flash memory, and the like. The storage 120 stores an operating system (OS), application programs, and other programs and data used by the controller 110 to perform the various processes. Moreover, the storage 120 stores data generated or acquired as a result of the controller 110 performing the various processes. For example, the storage 120 stores a notification table 121.

The communicator 130 includes a communication interface for communicating with external apparatuses of the power supply device 10. For example, the communicator 130 communicates with external apparatuses such as the robot 20 and a personal computer (PC) in compliance with known communication standards such as a local area network (LAN) and a universal serial bus (USB). Further, the communicator 130 may communicate with the robot 20 via short-range wireless communication such as near field communication (NFC) and Bluetooth (registered trademark)

Next, the functional configuration of the controller 110 is described. As illustrated in FIG. 6, the controller 110 functionally includes a power supplying controller 111 and a notification controller 112. In the controller 110, the CPU reads the program stored in the ROM into the RAM, and executes that program, thereby functioning as the various components described above.

The power supplying controller 111 controls power supply from the power supply device 10 to the robot 20. The power supplying controller 111 transmits a switch signal between ON and OFF to the switch 14, and switches between supply and cutoff of power from the AC adapter 17 to the power supplier (the transmission module 11 and the transmission antenna 12).

Specifically, upon detecting that the robot 20 moves to a space on or above the stand 18, the power supplying controller 111 transmits an ON signal to the switch 14, and starts supply of power to the transmission module 11. Further, upon detecting that the robot 20 moves away from a space on or above the stand 18, the power supplying controller 111 transmits an OFF signal to the switch 14, and stops supply of power to the transmission module 11.

The power supplying controller 111 communicates with the robot 20 via the communicator 130, and thus detects whether the robot 20 is placed on or above the stand 18 and whether the battery 24 reached a full charge. For example, the power supplying controller 111 communicates with the robot 20 via appropriate wireless communication such as a LAN, Bluetooth (registered trademark), and an NFC. In the robot 20, in a case where the robot 20 moves to a space above the stand 18, the control module 230 notifies, via wireless communication, the power supply device 10 that the robot 20 has moved to a space on or above the stand 18. The same also applies to a case where the robot 20 moves away from a space on or above the stand 18 and a case where the battery 24 has reached a full charge.

The notification controller 112 lights the LEDs of the notifier 16 in white while on standby, lights or flashes the LEDs of the notifier 16 in orange while charging, and lights or flashes the LEDs of the notifier 16 in green while full charge. As a result, the user can confirm whether the robot 20 is being charged or has completed charging.

Next, with reference to FIG. 7, a configuration of the control module 230 of the robot 20 is described. The control module 230 includes a controller 240, a storage 250, and a communicator 260.

The controller 240 includes a CPU. In one example, the CPU is a microprocessor or the like, and is a central processing unit that executes a variety of processing and computations. In the controller 240, the CPU controls actions of the entire robot 20 by reading a control program stored in a ROM and using a RAM as a work memory. The controller 240 may also be called a “processor.”

The storage 250 includes a ROM, a RAM, a flash memory, and the like. The storage 250 stores an OS, application programs, and other programs and data used by the controller 240 to perform the various processes. Moreover, the storage 250 stores data generated or acquired as a result of the controller 240 performing the various processes. For example, the storage 250 stores data indicating a reference amount of charge and data indicating reference power consumption. The reference amount of charge is one example of a predetermined amount of charge.

The communicator 260 includes a communication interface for communicating with external apparatuses of the robot 20. For example, the communicator 260 communicates with external apparatuses such as the power supply device 10 and a PC in compliance with known communication standards such as a LAN and a USB. Further, the communicator 260 may communicate with the power supply device 10 via short-range wireless communication such as a NFC and Bluetooth (registered trademark).

Next, the functional configuration of the controller 240 is described. As illustrated in FIG. 7, the controller 240 functionally includes a power receiving controller 241 and a robot controller 242. In the controller 240, the CPU reads the program stored in the ROM into the RAM, and executes that program, thereby functioning as the various components described above.

The power receiving controller 241 starts charging the battery 24 upon determining that the robot 20 exists at the power supply position. Further, the power receiving controller 241 receives data indicating the amount of charge of the battery 24 measured by the charging IC 23, and in a case where a determination is made that the amount of charge of the battery 24 is less than the reference amount of charge, turns ON the energy saving mode so as to reduce power to be consumed in the action unit 200. In the energy saving mode, the robot 20 is caused to be in a sleep state while the action unit 200 and the like do not operate, to reduce power consumption. The sleep state is, for example, a state in which action of the servo motor is suppressed. The sleep state is a mode in which minimum power is used by the action unit 200 and the like so as to allow immediate restart of the robot 20. Conversely, in a case where a determination is made that the amount of charge of the battery 24 is equal to or greater than the reference amount of charge (for example, equal to or greater than the amount of charge corresponding to 99% of full charge, that is, in the vicinity of full charge), the power receiving controller 241 turns OFF the energy saving mode. As a result, since the power consumed by the servo motor becomes high, the action unit 200 is allowed to consume power equal to or greater than the reference power consumption that is based on the power consumption in the energy saving mode. Note that the full charge may be set as the reference amount of charge. In a case where the amount of charge of the battery 24 is equal to or greater than the reference amount of charge, power used to charge the battery 24 reduces. As such, if power consumed by the action unit 200 temporarily increases due to an erratic action of the robot 20 or the like, power supplied from the power supply device 10 to the robot 20 would be insufficient. In such a case, the power charged to the battery 24 is consumed, and thus, the battery 24 may be difficult to reach a full charge. Further, if power consumed by the action unit 200 temporarily increases, a difference between the power sent from the power supplier (the transmission module 11 and the transmission antenna 12) of the power supply device 10 and the power received by the power receiver (the reception antenna 21 and the reception module 22) of the robot 20 increases, and then, the power supply may possibly stop due to an error. In order to prevent this, the action unit 200 is made to allow consumption of power that is equal to or greater than the reference power consumption, so that the power supplied from the power supply device 10 to the robot 20 is not insufficient even if power consumed by the action unit 200 temporarily increases. As a result, the power charged to the battery 24 is not consumed, and thus, the battery 24 easily reaches a full charge. Further, if the action unit 200 is consuming power that is equal to or greater than the reference power consumption, even if power consumed by the action unit 200 temporarily increases, the power supply can be prevented from stopping due to an error. The power receiving controller 241 stops charging the battery 24 upon determining that the amount of charge of the battery 24 is a full charge. However, there is also power to be consumed by the action unit 200 other than power used for charging of the battery 24, power supply from the power supply device 10 to the robot 20 does not stop. As such, consumption of power charged to the battery 24 can be prevented after the battery 24 reached a full charge.

The robot 20 is a pet robot that resembles a small animal. As such, the robot controller 242 controls the driver 220 to execute a breathing action or an erratic action that resembles a small animal. The breathing action is executed by an action that the head 204 is lifted in a fixed interval by the vertical motor 222 of the driver 220. The erratic action is executed by an action that the head 204 is randomly lifted by the vertical motor 222 of the driver 220. When the energy saving mode is turned ON, the power consumption can be reduced by causing the vertical motor 220 to sleep in a case where the vertical motor 220 does not operate. In the energy saving mode, the other components such as the sensor 210, the driver 220, and control module 230 are caused to be in a sleep state as necessary to reduce power consumption. Thereby, for example, the minimum current value of the current flowing through the action unit 200 can be approximately 60 mA, and the power consumption other than charging of the battery 24 can be reduced. When the energy saving mode is turned OFF, the action unit 200 consumes power that is equal to or greater than the reference power consumption, and even if the power to be consumed by the action unit 200 temporarily fluctuates, it can ensure that power supplied from the power supply device 10 to the robot 20 is not insufficient. As a result, the power charged to the battery 24 is not consumed, and thus, the battery 24 easily reaches a full charge. Further, even if power consumed by the action unit 200 temporarily increases by the action unit 200 consuming power that is equal to or greater than the reference power consumption, the power supply can be prevented from stopping due to an error.

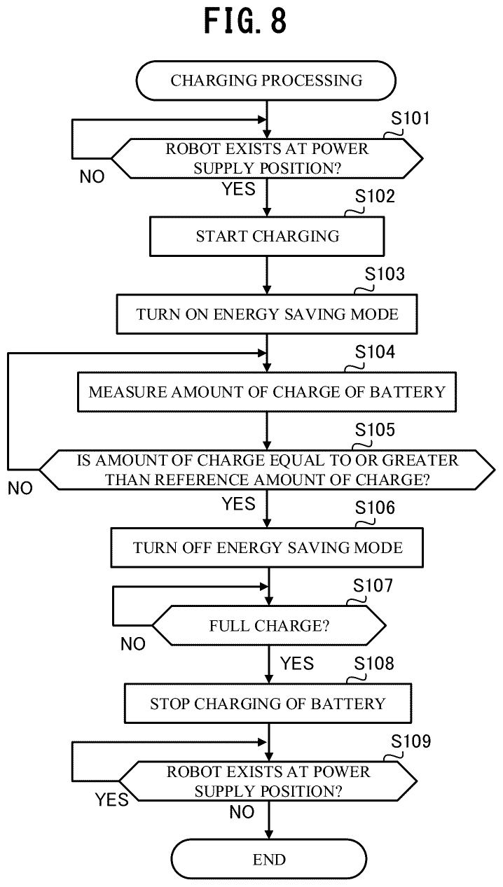

Next, with reference to FIG. 8, a flow of charging processing executed by the robot 20 is described. The charging processing illustrated in FIG. 8 is executed by the controller 240 of the control module 230. Note that the state is a standby state in which power is supplied to the power supply device 10 from the AC adapter 17, and the power supply device 10 is capable of normal operation. At this time, the controller 110 of the power supply device 10 lights the LEDs of the notifier 16 in white to indicate a standby state.

Once power supply processing starts, the controller 240 determines whether the robot 20 exists at the power supply position (step S101). Specifically, in a case where the controller 240 receives, via the communicator 260, notification that the robot 20 has moved to a space on or above the stand 18 of the power supply device 10, the controller 240 determines that the robot 20 exists at the power supply position.

In a case where a determination is made that the robot 20 does not exist at the power supply position (No in step S101), the controller 240 remains in step S101, and waits until the robot 20 moves to the power supply position.

In a case where a determination is made that the robot 20 exists at the power supply position (Yes in step S101), the controller 240 starts charging the battery 24 (step S102). Specifically, upon detecting that the robot 20 exists at the power supply position, the controller 110 of the power supply device 10 sets the switch 14 to ON, and starts supplying power to the power supplier (the transmission module 11 and the transmission antenna 12). In this way, an induced magnetic flux is generated from the transmission antenna 12, and the non-contact power supply starts. The reception antenna 21 of the robot 20 supplies the electromotive force induced in the power receiving coil to the reception module 22. The reception module 22 supplies power to the charging IC 22. The charging IC 23 charges the battery 24 and supplies power to the action unit 200. Further, once power supply to the robot 20 starts, the controller 110 of the power supply device 10 lights the LEDs of the notifier 16 in orange to indicate that the battery 24 is charging.

Next, the controller 240 turns on the energy saving mode to reduce power to be consumed by the action unit 200 (step S103). Specifically, the power supplied from the power supply device 10 is used to charge the battery 24 and is consumed in the action unit 200. The robot 20 is a pet robot that resembles a small animal. Thus, the action unit 200 controls the driver 220 to execute a breathing action or an erratic action that resembles a small animal. Due to control by the controller 240, the breathing action is executed by an action that the head 204 is lifted in fixed intervals by the vertical motor 222 of the driver 220. Due to control by the controller 240, the erratic action is executed by an action that the head 204 is randomly lifted by the vertical motor 222 of the driver 220. By turning ON the energy saving mode, the power consumption can be reduced by causing the vertical motor 220 to sleep in a case where the vertical motor 220 does not operate. In the energy saving mode, the other components such as the sensor 210, the driver 220, and control module 230 are caused to be in a sleep state as necessary to reduce power consumption. Thereby, for example, the minimum current value of the current flowing through the action unit 200 can be approximately 60 mA, and the power consumption other than charging of the battery 24 can be reduced. In a case where the amount of charge of the battery 24 is less than the reference amount of charge, the amount of current required for charging of the battery 24 is large. As such, even if the sleep state is released, fluctuation in values of overall current used to charge the battery 24 and consumed in the action unit 200 is less, and thus, power supply from the power supply device 10 is less likely interrupted.

Next, the controller 240 receives data indicating the amount of charge of the battery 24 measured by the charging IC 23 (step S104).

Then, the controller 240 determines whether the amount of charge of the battery 24 is equal to or greater than the reference amount of charge (step S105).

In a case where a determination is made that the amount of charge of the battery 24 is less than the reference amount of charge (No in step S105), the controller 240 returns to step S104, and repeats steps S104 to S105.

In a case where a determination is made that the amount of charge of the battery 24 is equal to or greater than the reference amount of charge (Yes in step S105), the controller 240 turns OFF the energy saving mode (step S106). As a result, the action unit 200 consumes power equal to or greater than the reference power consumption. In a case where the amount of charge of the battery 24 is equal to or greater than the reference amount of charge, power used to charge the battery 24 is small, and thus, power supplied from the power supply device 10 to the robot 20 is insufficient if the power consumed by the action unit 200 temporality fluctuates. In such a case, the power charged to the battery 24 is consumed, and thus, the battery 24 may be difficult to reach a full charge. Further, in a case where power consumed by the action unit 200 temporarily increases, a difference between the power sent from the power supplier (the transmission module 11 and the transmission antenna 12) of the power supply device 10 and the power received by the power receiver (the reception antenna 21 and the reception module 22) of the robot 20 increases, and then, the power supply may possibly stop due to an error. In order to prevent this, even if power to be consumed by the action unit 200 temporarily fluctuates by the action unit 200 consuming power that is equal to or greater than the reference power consumption, it ensures that power supplied from the power supply device 10 to the robot 20 is not insufficient. As a result, the power charged to the battery 24 is not consumed, and thus, the battery 24 easily reaches a full charge. Further, if the action unit 200 is consuming power that is equal to or greater than the reference power consumption, even in a case where power consumed by the action unit 200 temporarily increases, the power supply can be prevented from stopping due to an error.

Specifically, when the energy saving mode is turned OFF, the minimum current value of the current flowing through the action unit 200 can be approximately 120 mA. If the value of the current flowing through the action unit 200 changes to approximately 200 mA by the action unit 200 controlling the driver 200 and executing the breathing action or the erratic action, the value of current fluctuates from approximately 120 mA to approximately 200 mA. In this fluctuation width, power supplied from the power supply device 10 to the robot 20 is not insufficient and the power charged in the battery 24 is not consumed. As such, the battery 24 easily reaches a full charge, and the power supply can be prevented from stopping due to an error.

In contrast, when the energy saving mode is turned ON, the minimum current value of the current flowing through the action unit 200 is approximately 60 mA. In a case where the action unit 200 controls the driver 200 and executes the breathing action or the erratic action, the value of the current flowing through the action unit 200 changes to approximately 200 mA. In this case, the value of current fluctuates from approximately 60 mA to approximately 200 mA. This might result in insufficient power supplied from the power supply device 10 to the robot 20 and the power charged in the battery 24 is consumed, and consequently the battery 24 does not easily reach a full charge, and power supply may possibly stop due to an error.

Next, the controller 240 receives data indicating the amount of charge of the battery 24 measured by the charging IC 23, and determines whether the amount of charge of the battery 24 is a full charge (step S107).

In a case where a determination is made that the amount of charge of the battery 24 is not a full charge (No in step S107), the controller 240 remains in step S107, and waits until the amount of charge of the battery 24 reaches a full charge.

In a case where a determination is made that the amount of charge of the battery 24 is s full charge (Yes in step S107), the controller 240 stops charging the battery 24 (step S108). At this time, the controller 110 of the power supply device 10 lights the LEDs of the notifier 16 in green to indicate that the battery 24 is fully charged. However, there is also power to be consumed by the action unit 200 other than charging of the battery 24, the controller 240 continues receiving power from the power supply device 10 and controls not to use the power charged to the battery 24. As such, consumption of power charged to the battery 24 can be prevented after the battery 24 reached a full charge.

Next, the controller 240 determines whether the robot 20 exists at a power supply position (step S109).

In a case where a determination is made that the robot 20 exists at the power supply position (Yes in step S109), the controller 240 remains in step S109, and waits until the robot 20 moves from the power supply position.

In a case where a determination is made that the robot 20 does not exist at the power supply position (No in step S109), the power supply processing is ended.

As described above, the robot 20 according to Embodiment 1 turns OFF the energy saving mode upon determining that the amount of charge of the battery 24 is equal to or greater than the reference amount of charge. As a result, even if the power consumed by the action unit 200 temporarily fluctuates by the action unit 200 consuming power that is equal to or greater than the reference power consumption, it can ensure that power supplied from the power supply device 10 to the robot 20 is not insufficient. As a result, the power charged to the battery 24 is not consumed, and thus, the battery 24 easily reaches a full charge, and the charging state can preferably be maintained. Further, if the action unit 200 is consuming power that is equal to or greater than the reference power consumption, even if power consumed by the action unit 200 temporarily increases, the power supply can be prevented from stopping due to an error.

### Modified Examples

Embodiments of the present disclosure are described above, but these embodiments are merely examples and do not limit the scope of application of the present disclosure. That is, various applications of the embodiments of the present disclosure are possible, and all embodiments are included in the scope of the present disclosure.

The embodiments described above are directed to an example in which in a case where the controller 240 determines that the amount of charge of the battery 24 is equal to or greater than the reference amount of charge, the controller 240 turns OFF the energy saving mode. A configuration is possible in which in a case where a determination is made that the amount of charge of the battery 24 is equal to or greater than the reference power consumption, the controller 240 consumes power that is equal to or greater than the reference amount of charge using a method other than turning OFF the energy saving mode. For example, the controller 240 may consume power that is equal to or greater than the reference power consumption by passing a current through a resistor. As a result, the power charged to the battery 24 is not consumed, and thus, the battery 24 easily reaches a full charge, and the charging state can preferably be maintained.

The embodiments described above are directed to an example in which the head 204 of the robot 20 is rotatably coupled to the torso 206 by the twist motor 221 and the vertical motor 222, with a left-right direction and the front-back direction of the robot 20 as axes. In a case where a determination is made that the robot 20 exists at the power supply position, the controller 240 may limit the movable range of the twist motor 221 and the vertical motor 222. This allows to limit the movable range in which a movable portion moves with respect to the robot body. For example, the movable range of the twist motor 221 may set to be 0 degrees and the movable range of the vertical motor 222 may set to be 50 degrees or less. This configuration enables the power receiver of the robot 20 not to deviate from the power supplier of the power supply device 10 while the robot 20 exists at the power supply position.

In the embodiments described above, the exterior 201 is formed in a barrel shape from the head 204 to the torso 206, and the robot 20 has a shape as if lying on its belly. However, the robot 20 is not limited to resembling a living creature that has a shape as if lying on its belly. For example, a configuration is possible in which the robot 20 has a shape provided with arms and legs, and resembles a living creature that walks on four legs or two legs.

In the embodiments described above, in the controller 110, the CPU executes the program stored in the ROM to function as the various components, namely, the power supplying controller 111 and notification controller 112. Further, in the controller 240, the CPU executes the program stored in the ROM to function as the various components, namely, the power receiving controller 241 and the robot controller 242. However, in the present disclosure, the controllers 110, 240 are not limited to being processed by only one CPU, but may be processed jointly by multiple CPUs. Further, the controllers 110, 240 may include, for example, dedicated hardware such as an Application Specific Integrated Circuit (ASIC), a Field-Programmable Gate Array (FPGA), various control circuitry, or the like instead of the CPU, and this dedicated hardware may function as the various components, namely the power supplying controller 111, the notification controller 112, the power receiving controller 241, and the robot controller 242. In this case, the functions of each of the components may be realized by individual pieces of hardware, or the functions of each of the components may be collectively realized by a single piece of hardware. Additionally, the functions of each of the components may be realized in part by dedicated hardware and in part by software or firmware.

Additionally, any method may be used to apply the program. For example, the program can be applied by storing the program on a non-transitory computer-readable recording medium such as a flexible disc, a compact disc (CD) ROM, a digital versatile disc (DVD) ROM, and a memory card. Furthermore, the programs can be superimposed on a carrier wave and applied via a communication medium, such as the Internet. For example, the programs may be posted to and distributed via a bulletin board system (BBS) on a communication network. Moreover, a configuration is possible in which the processing described above is executed by starting the program and, under the control of the operating system (OS), executing the program in the same manner as other applications/programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A power receiving system comprising:
a power receiver to receive power from a power supply device that sends power corresponding to power consumption and power to be used for charging of a robot that is a target for power supply;
a battery accommodated in the robot and to be charged with power received by the power receiver; and
one or more processors to control the robot, wherein
in a case where a determination is made that an amount of charge of the battery is determined to be less than a predetermined amount of charge, the one or more processors set an energy saving mode of the robot, and in a case where a determination is made that the amount of charge of the battery is equal to or greater than the predetermined amount of charge, the one or more processors release setting of the energy saving mode and controls to receive power that is equal to or greater than a reference power consumption corresponding to the energy saving mode.

2. The power receiving system according to claim 1, wherein
in a case where a determination is made that the battery is full charge, the one or more processors continue receiving power from the power supply device and controls not to use power charged to the battery.

3. The power receiving system according to claim 1, wherein
the predetermined amount of charge is in vicinity of full charge.

4. The power receiving system according to claim 1, wherein
the predetermined amount of charge is full charge.

5. A robot comprising:
the power receiving system according to claim 1, wherein
the robot includes a robot body and a movable portion that connects to the robot body and is moved by the one or more processor, and
the one or more processor limit a movable range of the movable portion in a case where a determination is made that the robot exists at a power supply position.

6. A power receiving method comprising:
by a power receiving system including a power receiver to receive power from a power supply device that sends power corresponding to power consumption and power to be used for charging of a robot that is a target for power supply, and a battery accommodated in the robot and to be charged with power received by the power receiver,
in a case where a determination is made that an amount of charge of the battery is determined to be less than a predetermined amount of charge, setting an energy saving mode of the robot, and in a case where a determination is made that the amount of charge of the battery is equal to or greater than the predetermined amount of charge, releasing setting of the energy saving mode and controlling to receive power that is equal to or greater than a reference power consumption corresponding to the energy saving mode.

7. A non-transitory computer-readable recording medium storing a program, the program causing a computer to control a robot including a power receiver to receive power from a power supply device that sends power corresponding to power consumption and power to be used for charging of the robot that is a target for power supply, and a battery accommodated in the robot and to be charged with power received by the power receiver, to execute processing comprising:
in a case where a determination is made that an amount of charge of the battery is determined to be less than a predetermined amount of charge, setting an energy saving mode of the robot, and in a case where a determination is made that the amount of charge of the battery is equal to or greater than the predetermined amount of charge, releasing setting of the energy saving mode and controlling to receive power that is equal to or greater than a reference power consumption corresponding to the energy saving mode.
